(19) United States
(12) Patent Application Publication
(10) Pub. No.: US 2015/0037195 A1
(43) Pub. Date: Feb. 5, 2015

(54) METHOD FOR MAKING INDUCTOR MECHANISM

(71) Applicant: Chien Chih LIU, Hsinchu (TW)

(72) Inventor: Chien Chih LIU, Hsinchu (TW)

(73) Assignee: MAG. LAYERS SCIENTIFIC TECHNICS CO., LTD., Hsinchu (TW)

(21) Appl. No.: 13/956,618

(22) Filed: Aug. 1, 2013

(51) Int. Cl. H01F 41/04; B22F 7/08; B22F 3/14

(52) U.S. Cl. CPC H01F 41/041; B22F 3/14; B22F 7/08
USPC 419/8; 419/66; 29/602.1

(57) ABSTRACT

A method for making an inductor mechanism which includes a base member having two opposite side portions, a bottom portion, and an upper portion, a conductive coil member engaged in the base member and having two terminals extended toward the side portions of the base member, two conductive coverings are attached to the side portions of the base member and electrically connected to the terminals of the coil member, and two electro-plated devices are attached to the conductive coverings respectively. The electro-plated devices each include an inner layer attached onto the covering, and one or more further layers attached onto the inner layer, the layers are made of copper, brass, nickel, tin, or silver, or the like.

### BACKGROUND OF THE INVENTION

1. Field of the Invention

The present invention relates to an inductor device or mechanism, and more particularly to a method for making or manufacturing an inductor mechanism which includes a structure for increasing the contact area for the terminals of the inductor mechanism and for preventing the terminals of the inductor mechanism from becoming failure or from being damaged or disconnected or disengaged from other electrical facilities or products and for reducing or decreasing or preventing the defective products from being generated.

2. Description of the Prior Art

Typical inductors have been developed and provided for inducing the current and comprise one or more cores and one or more coils or conductive members wound or attached or mounted or engaged onto and around the core for inducing or generating the current.

For example, U.S. Pat. No. 5,751,203 to Tsutsumi et al., U.S. Pat. No. 6,154,112 to Aoba et al., and U.S. Pat. No. 7,042,324 to Watanabe disclose several of the typical inductors each comprising one or more coils or conductive members engaged into a drum-shaped core member for inducing or generating the electric current, and a cylindrical core disposed around the drum-shaped core and the coil, and a terminal table attached or mounted or engaged onto the drum-shaped core and the coil and the cylindrical core.

The typical inductors include a coil having two ends drawn through a gap that is formed between the terminal table and the drum-shaped core and the coil and the cylindrical core for coupling or connecting to winding terminals.

However, recently, the electrical facilities or electrical products have been developed and become more and more compact in size or volume, such that only a tiny space or volume or chamber is formed or provided in the electrical facilities or electrical products for receiving or accommodating various kinds of electrical parts or elements therein, and the ends or the terminals of the coil may have a good chance to be disconnected or disengaged from the other electrical parts or elements of the electrical facilities or electrical products, and the electrical shortage may have a good chance to be happened or generated in the electrical facilities or electrical products.

The present invention has arisen to mitigate and/or obviate the afore-described disadvantages of the conventional inductive members or inductor mechanisms.

### SUMMARY OF THE INVENTION

The primary objective of the present invention is to provide a method for making or manufacturing an inductor mechanism which includes a structure for increasing the contact area for the terminals of the inductor mechanism and for preventing the terminals of the inductor mechanism from becoming failure or from being damaged or disconnected or disengaged from other electrical facilities or products and for reducing or decreasing or preventing the defective products from being generated.

In accordance with one aspect of the invention, there is provided a method for making an inductor mechanism, comprising preparing a base member including two opposite side portions, a bottom portion, and an upper portion, and including a conductive coil member engaged in the base member, and the coil member including two terminals extended toward the side portions of the base member respectively, attaching two conductive coverings to the side portions of the base member respectively and electrically connecting the coverings to the terminals of the coil member respectively, and applying two electro-plated devices to the coverings respectively.

The electro-plated devices each include a first layer electroplated onto the conductive covering respectively, a second layer electroplated onto the first layer respectively. The electro-plated devices each include a third layer electroplated onto the second layer respectively.

The second layer and the third layer include a thickness ranging between 0.01 and 30 μm. The first layer include a thickness ranging between 5 and 100 μm. The first layer and the second layer are made of a material selected from copper, brass, nickel, tin, or silver.

The coil member includes a cross section selected from circular, elliptical, or olivary cross section. The coverings includes a thickness ranging between 0.01 and 30 μm. The coverings are attached to the side portions of the base member with a process selected from electroplating, chemical-plating, or sputtering. The base member includes a metallic powder and an organic resin material mixed and molded together, or hot-pressed together selectively.

The metallic powder is selected from carbonyl iron powder, iron-based alloy powder, or amorphous iron-based alloy powder. The metallic powder includes an outer diameter ranging between 1 and 100 μm. The organic resin material of the base member includes a weight ratio ranging between 1 and 10%.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a cross sectional view of an inductor mechanism to be made with a method in accordance with the present invention;

FIG. 2 is a flow chart illustrating the processes or procedures of the method in accordance with the present invention;

FIG. 3 is a perspective view of a prototype or original inductor member of the inductor mechanism; and

FIGS. 4, 5 are cross sectional views similar to FIG. 1, illustrating the processes or procedures of the method in accordance with the present invention.

### DETAILED DESCRIPTION OF THE PREFERRED EMBODIMENT

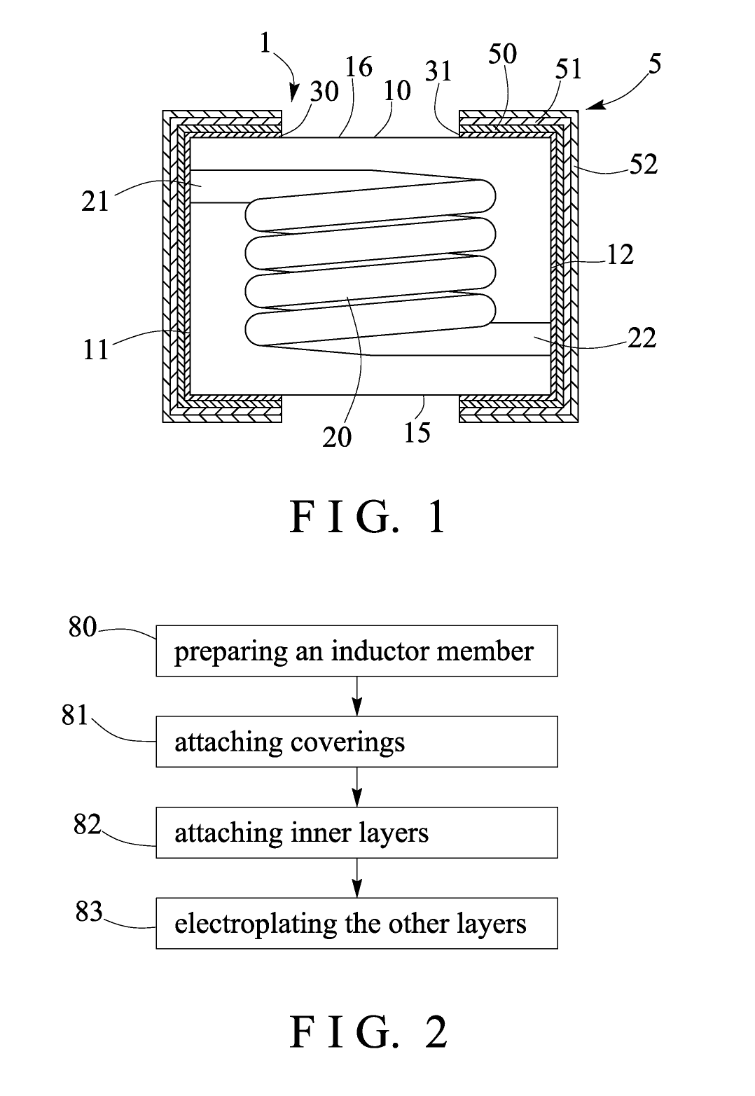

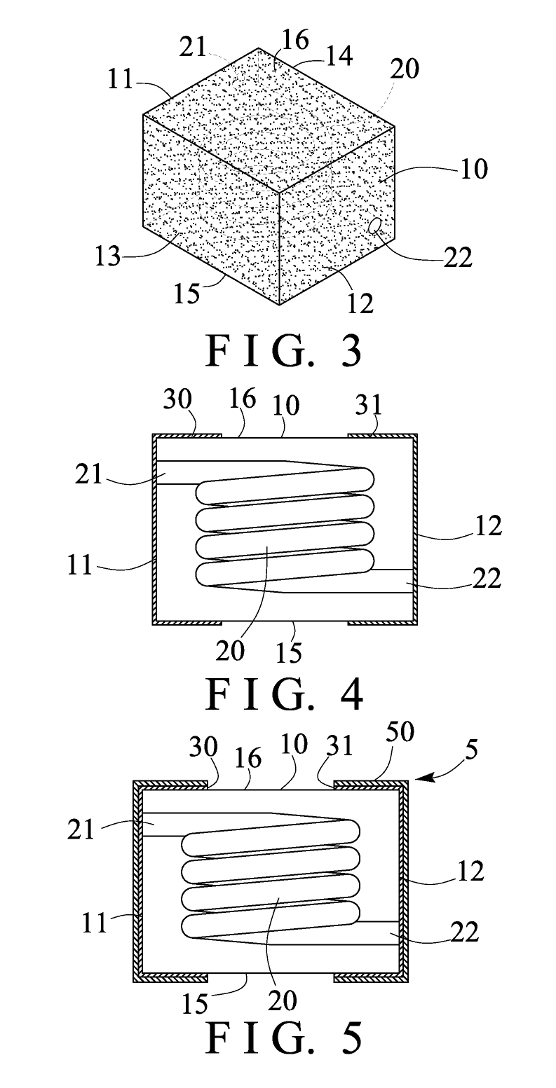

Referring to the drawings, and initially to FIGS. 1-3, a method in accordance with the present invention is provided for making or manufacturing or preparing (process 80) an inductor mechanism 1 which comprises a primary body or core or base member 10 (FIG. 3) including a substantially parallelepiped shape or structure having two opposite end or side walls or surfaces or portions 11, 12, a front wall or surface or portion 13, a rear wall or surface or portion 14, a bottom wall or surface or portion 15, and an upper wall or surface or portion 16. The core or base member 10 is made or formed by or includes metallic or magnetic powders, but not electrically conductive materials, and organic resin materials mixed together and made or formed by molding and/or hot-pressing and/or curing procedures.

For example, the magnetic or metallic powders may be selected from carbonyl iron powder, iron-based alloy powder, amorphous iron-based alloy powder, or the like, and may include an outer diameter ranging between 1 and 100 μm, the organic resin materials for the base member 10 may include a weight percentage or ratio of the base member 10 ranging between 1 and 10%. The base member 10 further includes a conductive device or coil member 20 disposed or fitted or embedded or engaged within the base member 10, and the coil member 20 includes two terminals 21, 22 extended or provided or directed toward the two opposite side portions 11, 12 of the base member 10, and preferably exposed or flush with the opposite side portions 11, 12 of the base member 10 respectively. It is preferable, but not necessarily that the coil member 20 is covered or coated or applied with an outer painted or coated or applied covering layer, and may be made of the materials selected from copper, brass, nickel, tin, or silver, or the like, and the terminals 21, 22 and/or the coil member 20 may include a circular or elliptical or olivary cross section or the like.

The inductor mechanism 1 further includes two adhesive membranes or conductive coating members or coverings 30, 31 and disposed or attached or mounted or secured or coated or printed or painted or applied onto the two opposite side portions 11, 12 of the base member 10 respectively and electrically contacted and connected or coupled to the terminals 21, 22 of the coil member 20 respectively (FIG. 1), in which the conductive coating members or coverings 30, 31 may be made of the materials selected from copper, brass, nickel, tin, or silver, or the like, or may be made of the conductive resin materials and/or soldering materials, and the coverings 30, 31 may be printed or painted or applied or electroplated onto the two opposite side portions 11, 12 of the base member 10 respectively in a covering attaching process 81 (FIG. 2).

The coverings 30, 31 are also partially disposed or attached or mounted or secured or coated or printed or painted or applied onto the bottom portion 15 and/or the upper portion 16 and/or the side portions 11, 12 of the base member 10 respectively for allowing the conductive coverings 30, 31 to be solidly and stably anchored or secured or retained to the base member 10. The inductor mechanism 1 further includes two conductive coating element or electro-plated devices 5 disposed or attached or mounted or secured or coated or printed or painted or applied onto the two coverings 30, 31 respectively, and the electro-plated devices 5 each may include one or more electro-plated layers 50, 51, 52 disposed or attached or mounted or secured or coated or printed or painted or applied onto the outer peripheral portion of the two coverings 30, 31 respectively.

For example, the one or more layers 50, 51, 52 of the electro-plated devices 5 may be made of the materials selected from copper, brass, nickel, tin, or silver, or the like, and the electro-plated devices 5 each include an inner or first layer 50 disposed or attached or mounted or secured or coated or printed or painted or applied onto the outer peripheral portion of the covering 30, 31 respectively in an inner layer attaching process 82 (FIG. 2), a middle or intermediate or second layer 51 is disposed or attached or mounted or secured or coated or printed or painted or applied onto the outer peripheral portion of the inner or first layer 50 respectively in an electroplating process 83 (FIG. 2), and an outer or third layer 52 disposed or attached or mounted or secured or coated or printed or painted or applied onto the outer peripheral portion of the middle or intermediate or second layer 51 respectively also in the electroplating process 83 (FIG. 2).

For example, the layers 50, 51, 52 of the electro-plated devices 5 may be electro-plated, chemical-plated, or sputtered onto the coverings 30, 31 respectively, the coverings 30, 31 may include a dimension or standard or thickness ranging between 0.01 and 30 μm, the inner or first layers 50 may include a thickness ranging between 5 and 100 μm, the middle or intermediate or second layers 51 may include a thickness ranging between 0.01 and 30 μm, and the outer or third layers 52 may also include a thickness ranging between 0.01 and 30 μm. The coverings 30, 31 may also be electro-plated, chemical-plated, or sputtered onto the opposite side portions 11, 12 of the base member 10 respectively.

It is to be noted that the coil member 20 may be made of the materials selected from copper, brass, nickel, tin, or silver, or the like, and the conductive coverings 30, 31 may also be made of the materials selected from copper, brass, nickel, tin, or silver, or the like and may be suitably and electrically connected or coupled to the terminals 21, 22 of the coil member 20 and may suitably increase the conductive area for the terminals 21, 22 of the coil member 20 and also for the layers 50, 51, 52 of the electro-plated devices 5, and thus may prevent the terminals 21, 22 of the coil member 20 of the inductor mechanism 1 from becoming failure or from being damaged or disconnected or disengaged from other electrical facilities or products and for reducing or decreasing or preventing the defective products from being generated, or the defective rate for the products may be suitably reduced or decreased.

Accordingly, the method in accordance with the present invention may be provided for making or manufacturing an inductor mechanism which includes a structure for increasing the contact area for the terminals of the inductor mechanism and for preventing the terminals of the inductor mechanism from becoming failure or from being damaged or disconnected or disengaged from other electrical facilities or products and for reducing or decreasing or preventing the defective products from being generated.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for making an inductor mechanism, comprising:
preparing a base member including two opposite side portions, a bottom portion, and an upper portion, and including a conductive coil member engaged in said base member, and said coil member including two terminals extended toward said side portions of said base member respectively,
attaching two conductive coverings to said side portions of said base member respectively and electrically connecting said coverings to said terminals of said coil member respectively, and
applying two electro-plated devices to said coverings respectively.

2. The method as claimed in claim 1, wherein said electro-plated devices each include a first layer electroplated onto said conductive covering respectively, a second layer electroplated onto said first layer respectively.

3. The method as claimed in claim 2, wherein said electro-plated devices each include a third layer electroplated onto said second layer respectively.

4. The method as claimed in claim 3, wherein said second layer and said third layer include a thickness ranging between 0.01 and 30 μm.

5. The method as claimed in claim 2, wherein said first layer include a thickness ranging between 5 and 100 μm.

6. The method as claimed in claim 2, wherein said first layer and said second layer are made of a material selected from copper, brass, nickel, tin, or silver.

7. The method as claimed in claim 1, wherein said coil member includes a cross section selected from circular, elliptical, or olivary cross section.

8. The method as claimed in claim 1, wherein said coverings includes a thickness ranging between 0.01 and 30 μm.

9. The method as claimed in claim 1, wherein said coverings are attached to said side portions of said base member with a process selected from electroplating, chemical-plating, or sputtering.

10. The method as claimed in claim 1, wherein said base member includes a metallic powder and an organic resin material mixed and molded together.

11. The method as claimed in claim 1, wherein said base member includes a metallic powder and an organic resin material mixed and hot-pressed together.

12. The method as claimed in claim 11, wherein said metallic powder is selected from carbonyl iron powder, iron-based alloy powder, or amorphous iron-based alloy powder.

13. The method as claimed in claim 11, wherein said metallic powder includes an outer diameter ranging between 1 and 100 μm.

14. The method as claimed in claim 11, wherein said organic resin material of said base member includes a weight ratio ranging between 1 and 10%.
